(19) United States
(12) Patent Application Publication
(10) Pub. No.: US 2022/0058178 A1
(43) Pub. Date: Feb. 24, 2022

(54) STORAGE SYSTEM FACILITATING STORAGE OF CONFIGURATION OF SERVICES AND A METHOD THEREOF

(71) Applicant: HCL America Inc., Sunnyvale, CA (US)

(72) Inventor: Prafull VERMA, Sunnyvale, CA (US)

(21) Appl. No.: 17/000,909

(22) Filed: Aug. 24, 2020

(51) Int. Cl. G06F 16/23; G06F 11/14

(52) U.S. Cl. CPC G06F 16/2379; G06F 2201/85; G06F 11/142

(57) ABSTRACT

The present disclosure relates to a storage system and method facilitating storage of configuration of services in a storage system. A list of services for one or more application is stored in the storage system. One or more microservices facilitating operation of each service from the list of services are then stored in the storage system. The one or more microservices are configured along with one or more attributes associated with each of the microservice. The one or more microservices in the storage system are configured according to a relationship between each of the service and the one or more microservices facilitating with the service.

### CROSS-REFERENCE TO RELATED APPLICATIONS AND PRIORITY

The present application does not claim priority from any patent application.

### TECHNICAL FIELD

The present disclosure in general relates to a field of service configuration. More particularly, the present disclosure relates to system and method for storing configuration of services and microservices.

### BACKGROUND

In current technical era, development of microservices has increased for facilitating smooth operation of services. Microservices play a vital role in software architecture. Large and heavy services can be complex and therefore, such services are divided or configured in terms of plurality of small microservices. Each of the microservice is developed with a role.

Configuration Management Database (CMDB) is widely used by any organization to keep a track of all type of assets such as products, systems, software, and much more. The CMDB also helps in identifying relation between one or more type of assets stored in the CMDB.

Though CMDB is very helpful in knowing composition of Information Technology (IT) infrastructure, however, the CMDB may not be very effective when a clear vision of all type of microservices constituting a service is needed. In lack of such vision through the CMDB, any fault in smooth operation of any service may not be identified. Furthermore, the CMDB involve complexity in identifying root cause in case of failures in the service.

### SUMMARY

Before the present system and method facilitating configuration storage of services in a storage system is described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is not intended to identify essential features of the claimed subject matter nor is it intended for use in determining or limiting the scope of the claimed subject matter.

In one implementation, the storage system facilitating storage of configuration of services is shown. The storage system comprises of a processor, a memory coupled to the processor. The memory is configured to store a set of instructions to be executed by the processor. The processor is configured to store, in the storage system, a list of services for one or more application and store, in the storage system, one or more microservices configured for facilitating operation of each service from the list of services. The one or more microservices are configured along with one or more attributes associated with each of the microservice. Configuration of the one or more microservices are stored in the storage system along with a relationship between each of the service and the one or more microservices facilitating the service.

In another implementation, a method providing facilitating storage of configuration of services in a storage system is shown. The method comprises of storing, in the storage system, a list of services for one or more application and storing, in the storage system, one or more microservices configured for facilitating operation of each service from the list of services. The one or more microservices are configured along with one or more attributes associated with each of the microservice. The one or more microservices in the storage system are stored along with a relationship between each of the service and the one or more microservices facilitating with the service.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a storage system 102 providing configuration of services, in accordance with an embodiment of the present subject matter.

FIG. 2 illustrates an architecture of the storage system 102 for facilitating storage of configuration of services, in accordance with an embodiment of the present subject matter.

FIG. 3(a) illustrates an architecture of services and corresponding microservices services stored in the storage system 102, in accordance with an embodiment of the present subject matter.

FIG. 3(b) illustrates an exemplary architecture showing a service and corresponding microservices stored in the storage system 102, in accordance with an embodiment of the present subject matter.

FIG. 4 illustrates a flowchart for a method 400 facilitating configuration storage of services in the storage system 102, in accordance with an embodiment of the present subject matter.

### DETAILED DESCRIPTION

Some embodiments of the present disclosure, illustrating all its features, will now be discussed in detail. The words “comprising”, “receiving”, “determining”, “assigning” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a”, “an” and “the” include plural references unless the context clearly dictates otherwise. Although any systems and methods similar or equivalent to those described herein can be used in the practice or testing of embodiments of the present disclosure, the exemplary, systems and methods for assigning dynamic operation of devices in a communication network are now described. The disclosed embodiments of the systems and methods for assigning dynamic operation of devices in a communication network are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure for assigning dynamic operation of devices in a communication network is not intended to be limited to the embodiments illustrated, but is to be accorded the widest scope consistent with the principles and features described herein.

Configuration Management Database (CMDB) is widely used by any organization to keep a track of all type of Configuration Items (CIs) such as products, systems, software, and much more. The CMDB also helps in identifying relation between one or more type of CIs stored in the CMDB.

Though CMDB is very helpful in knowing the underlying IT infrastructure of services, however, the CMDB may not be very effective when a clear vision of all type of microservices constituting a service is needed. In lack of such vision through the CMDB, any fault in smooth operation of any service may not be identified. Furthermore, the CMDB involve complexity in identifying root cause in case of failures in the service.

The present subject matter overcomes a problem of service configuration in a database. Proposed storage system and method provides a configuration of a list of services for one or more application by configuring one or more microservices facilitating operation of each service from the list of services. The one or more microservices are configured along with one or more attributes associated with each of the microservice. The one or more microservices in the storage system are configured according to a relationship between each of the service and the one or more microservices facilitating the service.

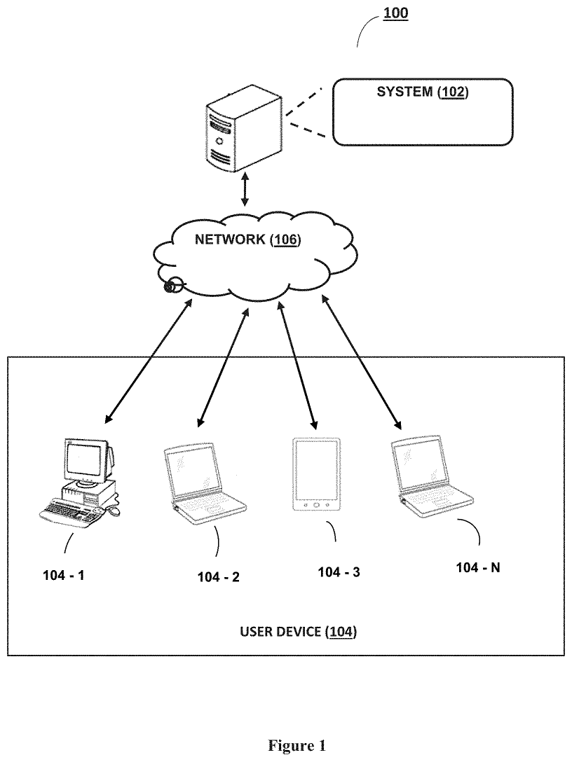

Referring now to FIG. 1, a network implementation 100 of a storage system 102 facilitating storage of services is disclosed. Although the present subject matter is explained considering that the storage system 102 is implemented on a server, it may be understood that the storage system 102 may also be implemented in a variety of computing systems, such as a laptop computer, a desktop computer, a notebook, a workstation, a mainframe computer, a server, a network server, and the like. In one implementation, the system 102 may be implemented over a cloud network. Further, it will be understood that the storage system 102 may be accessed by multiple users through one or more user devices 104-1, 104-2 . . . 104-N, collectively referred to as user device 104 hereinafter, or applications residing on the user device 104. Examples of the user device 104 may include, but are not limited to, a portable computer, a personal digital assistant, a handheld device, and a workstation. The user device 104 may be communicatively coupled to the storage system 102 through a network 106.

In one implementation, the network 106 may be a wireless network, a wired network or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

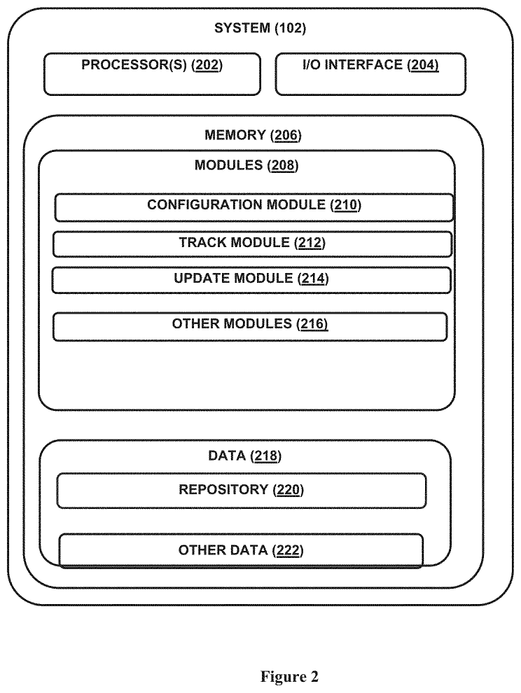

Referring to FIG. 2, configuration of the storage system 102 is shown. In one embodiment, the storage system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, at least one processor may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface may include one or more ports for connecting a number of devices to one another or to another server.

In one implementation, a user may access the storage system 102 via the I/O interface. The user may be registered using the I/O interface in order to use the system 102. In one aspect, the user may access the I/O interface of the system 102 for obtaining information, providing input information or configuring the system 102.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

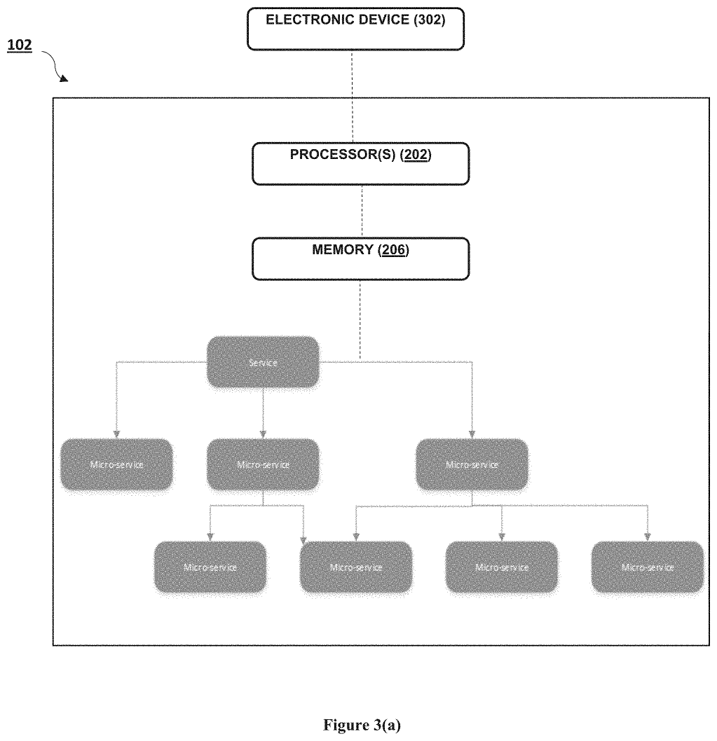

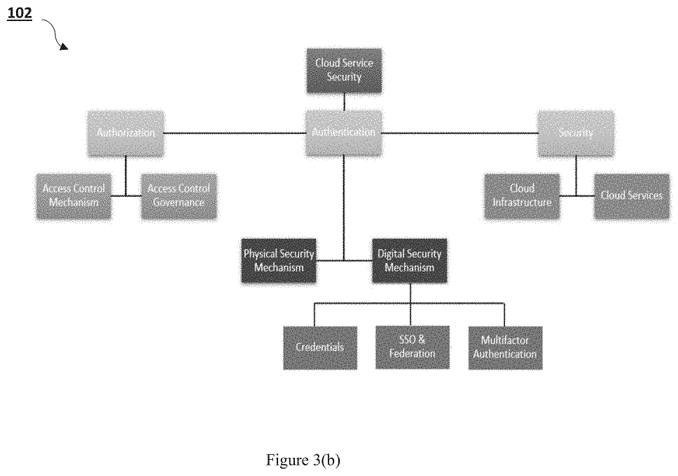

The memory 206 is connected to a plurality of modules 208. The modules 208 may be configured within the memory 206 as software modules 208 or the modules 208 may be connected to each of the processor 202, the I/O interface 204 and the memory 206 as hardware modules. The modules 208 comprises a configuration module 210 configured to store a list of services for one or more application, a track module 212 configured to track the improper functioning of the one or more microservice, an update module 214 configured to update the storage system 100, and other modules 216 for performing any miscellaneous function in the storage system 100. The system 102 also comprise data 218 stored in a repository 220 and other data 222. Data 218 relates to services and microservices data stored in the repository 220. The other data 222 refers to any data accessed by the storage system 100 for executing one or more operations while facilitating storage of configuration of services in a storage system 100. The other data 222 is also stored in the repository 220. In an exemplary embodiment, referring to FIG. 3(a), details of the storage system 102 will now be explained. The storage system 102 may be configured over a XaaS platform. XaaS is an operating model configured for delivering services to a user in a network by referring to different type of tools and products. An example of network may include internet network and examples of services delivered through XaaS may include but not limited to Google Apps, Amazon Web Services (AWS) and alike. The XaaS platform is configured for delivering one or more type of services to an electronic device 302 over a communication network. The XaaS platform comprises one of a Software as a Service (SaaS) platform, Platform as a service (PaaS), or an Infrastructure as a service (IaaS). The electronic device refers to the user device 104 as discussed above. The communication network comprises an internet network.

The configuration module 210 in the storage system 102 stores the list of services for one or more application. The list of services comprises at least one of an IT-based services or non-IT based services. Examples of IT-based services include a database service, a Virtual Machine (VM) service, an email service, a software service and alike while examples of non-IT based services include a cab service, an accommodation service, an employee onboarding service and alike. Each of the service is built upon one or more microservices. Examples of microservices include shipping microservice, notification microservice, payment microservice and alike.

The configuration module 210 further store details of the one or more microservices constituting the service. Each of the microservice constituting the service is having a relationship with other microservice constituting the service. The one or more microservices for one service are also related to the one or more microservices for another service. The relationship defines a communication of one of the microservice with other microservice and the service constituted by the microservice, as each of the microservice defines and constitutes a part of the service. Each of the microservice is configured though a programming language by using one or more libraries. The programming language by using one or more libraries defines the one or more attributes of the microservice.

The attributes are used for configuring the microservice. The attributes also include application configuration, database configuration, communication channel configuration for enabling communication between the one or more microservices and the service, and URLs of the one or more microservices.

The storage system 102 also stores relationship of one microservice with other one or more microservices. Since, the storage system 102 is a single platform providing details about each of the service and the one or more microservice associated with the service, the storage system 102 performs a mapping of the one or more microservice when a user requests for the service. Based on successful mapping of the service with corresponding microservice, the service is delivered to the user.

In case of improper functioning of the one or more microservices, the service may be declared as a faulty service. The storage system 102 uses the relationship between each of the service and the one or more microservices associated with the service for identifying a fault occurring in the delivery of the service. During the improper functioning, the one or more microservices may fail to deliver a desired operation required for delivering the service. The track module 212 may track the improper functioning of the one or more microservice and may report the improper functioning of the one or more microservice to the processor 202. The storage system 102 may then be updated through the update module 214 with corresponding microservice to overcome the fault in delivery of the service.

In an exemplary embodiment, table 1 below shows details of the service and corresponding microservices stored in the storage system 102 of the proposed description. The services and the corresponding microservices are stored in a tabulated architecture. Table 1 is an example showing details of the services and the microservices configured in the storage system 102. This is to be understood that any changes may be implemented in the storage system 102 and example in Table 1 is not adding any limitation to the scope of the proposed storage system 102.

TABLE 1

| | Column | Column Name | |
|---|---|---|---|
| Key | Name | Description | Sample Input |
| SER_NAME | Name | Name of service | Electronic |
| | | | Messaging |
| BUSS_CRT | Business | Criticality of service | 2 - somewhat |
| | Criticality | based on business | critical |
| | | impact | |
| lNST | Instances | Instance on which the | Production |
| | | service is used | |
| SERV_CLSF | Service | Type of service | Business |
| | Classification | | Service |
| SER_MGD | Service | Group/individual | SRE Group |
| | Managed by | responsible to manage | |
| | | the service | |
| SER_OWN | Service | Owner of service | Cheryl Jacob |
| | Owner by | | |
| APPR_GRP | Approval | Group responsible to | DRYiCE |
| | Group | provide approvals for | Support |
| | | performing changes in | Group |
| | | service | |
| APPR _IND | Approval | Individual responsible | James |
| | Individual | to provide approvals | Johnson |
| | | for performing changes | |
| | | in service | |
| SER_LOCN | Location | Source location to | migrateTest |
| | | connect to the service | |
| SER_STAT | Service Status | Active/Inactive status | Active |
| | | of service | |
| SER_SSTAT | Service Sub- | Sub-status values of | Operational |
| | Status | service | |
| | | Active - Operational | |
| | | Inactive - Under | |
| | | Maintenance, Paused, | |
| | | Retired | |
| SER_PRT | Parent Service | Name of parent service | Notification |
| | | of this service | Service |
| REF_ID | Reference ID | ID to uniquely identify | REF0004587 |
| | | relationship between | |
| | | the two services | |

In accordance with an embodiment, referring to FIG. 3(a) an architecture of the services and the corresponding microservices configured in the storage system 102 is shown. The services and the microservices are stored in the tabulated manner in rows and columns. The service may be connected to the one or more microservices and the microservice may also be connected (or may interact) with other one or more microservices as shown in FIG. 3(a).

FIG. 3(b) further shows an exemplary configuration of the services and the one or more microservices configured in the hierarchy in the storage system 102. Hierarchy shown in FIG. 3(b) is an example for which the intent is not to limit the scope of the storage system 102.

A service named as cloud service security (parent service) is stored with corresponding microservices namely authorization, authentication and security. The authorization microservice is further constituted by each of access control mechanism, and access control governance micro-services. Similarly, the authentication microservice is further constituted by other micro-services governed by each of physical security mechanism, and digital security mechanism. The digital security mechanism is further governed by each of credentials, SSO and federation and multifactor authentication micro-services. The security microservice is further governed by cloud infrastructure, and cloud services micro-services.

In FIG. 3(b) the proposed storage system 102 also helps in identifying the fault occurring for securing one or more cloud applications. If a user is not able to authenticate himself to access the cloud application due to the Cloud Service Security service in place, then the storage system 102 may identify that the failure in authentication may occur due to one of the physical security mechanism or the digital security mechanism micro-services. The storage system 102 may also drill down to identify in case the failure is due to one of the credentials, the SSO and federation or the multifactor authentication based on the relation between the services and the microservices. Thus, as explained in this example, the knowledge of relationship between the services and microservices plays an important role.

The storage system 102 through the update module 214 may report the cause of the failure by identifying a failed microservice associated with the service. In an example, the system 102 receives a service request from a user. The service request may be facilitated through a microservice 1, a microservice 2, and a microservice 3. Now, each of the microservice 1, the microservice 2, and the microservice 3 may interact with each other through APIs. Once the service request is fulfilled, the user is further notified through a notification microservice and status of the service is marked as completed.

In case the system 102 observes a failure in the microservice 2, then the operation of the service request may not be fulfilled. Such failure of the microservice 2 may be tracked by the system 102 using Track Module 212 and the system 102 may then trigger a warning notification to relevant stakeholders through the notification microservice so that appropriate action may be taken towards the failure of the microservice 2 and smooth operation of the service may be ensured.

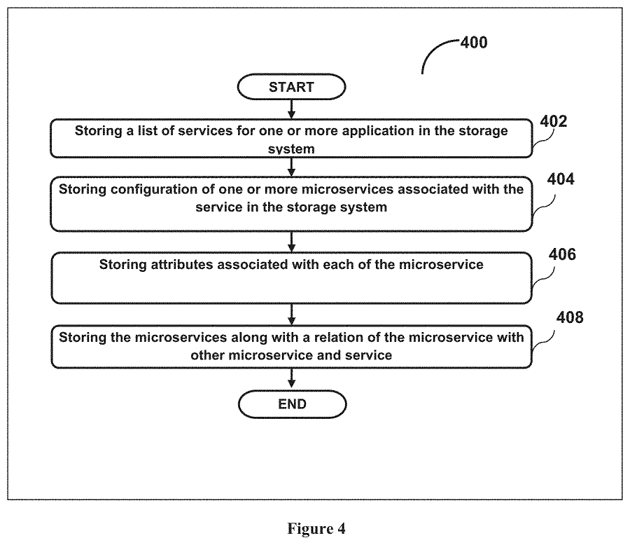

Referring now to FIG. 4, a method 400 facilitating storage of configuration of services in a storage system, is disclosed in accordance with an embodiment of the present subject matter. The method 400 may be described in the general context of computer executable instructions. Generally, computer executable instructions can include routines, programs, objects, components, data structures, procedures, modules, functions, and the like, that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method 400 can be implemented in any suitable hardware, software, firmware, or combination thereof. However, for ease of explanation, in the embodiments described below, the method 400 may be considered to be implemented in the above described storage system 102.

At block 402, storing, the list of services configured for the one or more application in the storage system 102.

At block 404, configuration of the one or more microservices facilitating operation of each service from the list of services is stored in in the storage system 102.

At block 406, the one or more microservices are stored along with one or more attributes associated with each of the microservice.

At block 408, the one or more microservices in the storage system are stored along with the relationship between each of the service and the one or more microservices facilitating the service.

Exemplary embodiments discussed above may provide certain advantages. Though not required to practice aspects of the disclosure, the advantages may include those provided by the following features.

Some embodiments of the storage system 102 and the method 400 may be configured to organize the services and the one or more microservices to capture all aspects of an IT infrastructure and have an organized central representation of services to ensure accuracy of information.

In an example, some embodiments of the storage system 102 and the method 400 may provide the configuration of micro-services architecture to make the system 102 capable of identifying failures of microservices and allows to track faults effectively by triggering warning notifications through a notification microservice, to support smooth operation of the service. In case of failure, the storage system 102 acts as a reference in order to understand relationships and perform root cause analysis of the fault. The root cause analysis makes it easier to ascertain the micro-service causing the issue, and also capture an impact of the microservices of the services.

Some embodiments of the storage system 102 and the method 400 may enhance visibility by giving up to date view of how various services are delivered without requiring manual mapping, as the proposed system 102 and the method 400 provides details about relationship between the service and the one or more microservices.

Some embodiments of the storage system 102 and the method 400 may increase the efficiency of an enterprise with a single source of truth for service architecture provided through the storage system 102 storing details about the services and the corresponding microservices.

Some embodiments of the storage system 102 and the method 400 may provide greater agility through precise analysis of impact that may be caused due to any change activity in configuration of the services and the microservices.

Some embodiments of the storage system 102 and the method 400 may help in visualizing complex architecture of the services and the corresponding microservices to understand impact and risk, make improved business decisions and provide enhanced services.

Although implementations for the storage system 102 and the method 400 for configuring the services, it is to be understood that the appended claims are not necessarily limited to the specific features or methods described. Rather, the specific features and methods are disclosed as examples of implementations for assigning dynamic operation of devices in a communication network.

1. A method facilitating storage of configuration of services in a storage system, the method comprising:
storing, in the storage system, a list of services configured for one or more application; and
storing, in the storage system, configuration of one or more microservices facilitating operation of each service from the list of services, wherein the one or more microservices are configured along with one or more attributes associated with each of the microservice;
wherein the one or more microservices stored in the storage system are configured according to a relationship between each of the service and the one or more microservices facilitating with the service.

2. The method as claimed in claim 1, wherein the relationship defines an interaction of each of the microservice with other one or more microservices and dependency of the one or more microservices with the service constituted by the one or more microservices.

3. The method as claimed in claim 1, comprising:
detecting, a fault in delivery of the service based on the relationship between each of the service and the one or more microservices associated with the service.

4. The method as claimed in claim 1, comprising:
detecting, a fault in the service by identifying a failed microservice from the one or more microservices; and
updating, through an Application Programming Interface (API), the failed microservice causing the fault, with an updated microservice.

5. The method as claimed in claim 1, wherein the list of services and the one or more microservices are stored in a tabulated manner.

6. A storage system facilitating storage of configuration of services, the storage system comprising:
a processor;
a memory coupled to the processor, wherein the memory is configured to store a set of instructions to be executed by the processor, wherein the processor is configured to:
store, in the storage system, a list of services for one or more application;
store, in the storage system, cone or more microservices configured for facilitating operation of each service from the list of services, wherein the one or more microservices are configured along with one or more attributes associated with each of the microservice;
wherein the one or more microservices in the storage system are configured according to a relationship between each of the service and the one or more microservices facilitating the service.

7. The system as claimed in claim 6, wherein the relationship defines an interaction of each of the microservice with other one or more microservice and the dependency of the one or more microservices with service constituted by the one or more microservices.

8. The system as claimed in claim 6, wherein the processor is configured to:
detect, a fault in delivery of the service based on the relationship between each of the service and the one or more microservices associated with the service.

9. The system as claimed in claim 8, wherein the processor is configured to:
detect, a fault in the service by identifying a failed microservice from the one or more microservices; and
update, the failed microservice causing the fault, with an updated microservice.

10. The system as claimed in claim 6, wherein the list of services and the one or more microservices are stored in a tabulated manner.
